(19) United States
(12) Patent Application Publication
(10) Pub. No.: US 2011/0088624 A1
(43) Pub. Date: Apr. 21, 2011

(54) METHOD FOR THE PROTECTION OF SKIN REGIONS OF A TEAT DURING THE MILKING PROCESS, AND FILM FOR SUCH A METHOD

(76) Inventor: Jochen Kenndoff, Hamburg (DE)

(21) Appl. No.: 12/999,094

(22) PCT Filed: Jun. 16, 2009
(86) PCT No.: PCT/EP09/04311

§ 371 Date: Dec. 15, 2010

(30) Foreign Application Priority Data
Jun. 19, 2008 (DE) 10 2008 029 172.2
Dec. 16, 2008 (DE) 20 2008 017 000.1

(51) Int. Cl. A01J 7/00; A01J 5/00; A01J 7/04

(52) U.S. Cl. 119/14.02; 119/14.01

(57) ABSTRACT

Disclosed is a method for protecting especially injured or stressed skin regions of a teat during the milking process. In said method, the teat is wrapped in an overlapping manner in a film that is a combination of planar support and an adhesive layer, by means of which the film sticks to itself and to the skin. The thickness and the elastic and/or plastic deformability of the adhesive layer are selected such that the adhesive layer compensates the shearing forces acting from the film onto the skin when the teat is stretched during the milking process, and/or the adhesive layer is selected in such as way as to detach from the skin without substantially injuring the corneocyte layer when a force acts on the adhesive layer in the longitudinal direction of the teat.

The invention relates to a method by which skin regions of teats can be protected with a film during and between milking operations. The invention further relates to films that can be used in the method.

One of the main objectives in agriculture concerns the efficient care and management of large herds of dairy animals for producing dairy products. Diseases of individual animals and significant deviations from what is normal for the herd are therefore a serious problem, since profitability is nowadays achieved for the most part through smooth and efficient management of very large herds. Diseases of individual animals and deviations from what is normal for the herd, especially as regards the area of the teat, are a considerably troubling factor that compromises profitability, particularly when using semiautomatic and fully automatic milking robots.

The fact is that the teats are considerably stressed by the milking process, and this can lead to irritation or, in particular, to the breaking of skin that is already irritated. Small injuries of this kind, even extremely small injuries, can lead to mastitis being triggered as a result of microbial attack.

If the skin of the teat is injured externally, the animals generally have to be housed separately and much more effort has to be expended in caring for them.

Even extremely small injuries in the area of the teat, which injuries can exude secretions, necessarily lead to segregation of the affected animal, since otherwise the milk can be contaminated with blood or wound secretions, and, on account of the downstream quality control, particularly in modern automated quality control systems, this generally leads to the milk taken from all the milked quarters being discarded.

In the case of slightly more extensive injuries, the udder quarter associated with the teat must in some cases even be drained in order to permit healing, since the teat is subjected to considerable stress by the milking process. Scabs that have formed are generally opened again by the high compressive and tensile loads. In the worst case, this even leads to an originally small injury on the teat becoming larger.

There is as yet no known way of protecting the teat during the milking process in a method that can be used with reasonable outlay on large herds of dairy animals.

The possibility of treating an already injured teat is known, but this generally means that the treated teat can be milked only with difficulty or is not milkable.

For injuries to the skin of the teat, it is customary to apply a teat bandage. This can be done, for example, using dips, by bandages that do not adhere to the skin but adhere to themselves, or also by planar, self-adhesive plaster materials that are suitable in principle for covering wounds.

All of these nowadays customary solutions for protecting and treating the teat have various disadvantages.

Dips which contain natural rubber, for example, can have a sensitizing effect. Bandages that are applied with the aid of dips and generally provide reliable protection must be removed again before each milking operation in order that the milking operation can take place at all. The work involved in removing the bandage is sometimes considerable. For example, the bandages have to be soaked before they can be removed again. In the worst case, friction wounds and bruising are caused by the actual removal of the bandage. Just how awkward the procedure is can be seen, for example, from the patent specification DE 699 14 751 for a polyurethane-based dip solution. Said specification also describes the disadvantages regarding the stability of water-soluble films.

Teat bandages with planar, self-adhesive plaster materials are used mainly for fixing. Fixomull (BSN), for example, is often used for this purpose as an elastic fixing bandage. The bandage is not designed to be placed in direct contact with the wound but is instead applied mainly to fix teat pins, for example, and has to be removed again for milking. A teat bandage of this kind is therefore unsuitable as a permanent protection that remains on the teat even during milking. The acrylate adhesives that are used here adhere with high adhesive strength, such that they irritate the skin during loading. Since the adhesive is applied in only a very thin layer to the flexible support, the adhesive itself cannot absorb tensile loads very well in the adhesive layer and instead transmits tensile forces and shearing forces directly to the skin. Moreover, the forces cannot in every case be compensated by the flexible support material, since the flexibility of the support is only assured in one direction, not in all directions. Therefore, mechanical loads, e.g. through movement, or tensile loads are not always completely absorbed, and instead are for the most part transmitted directly to the skin, which can lead to irritation, possibly itching, or to the adhesive connection coming loose. Specifically because of the irritating effect, such bandages are often licked off by the animals. If the adhesive bond comes loose as a result of the tensile and shearing forces, the bandage generally no longer adheres, since the uppermost stratum of the corneocyte is removed by the adhesive layer and adheres to the adhesive layer. Therefore, each time the bandage is changed, the uppermost layer of skin is always removed too. This effect known as corneocyte stripping occurs because the adhesive strength between the corneocytes on the skin is generally no longer sufficient and they are torn off with the bandage.

In addition to the basic problem of protecting animals during the milking process from irritations, etc., caused by the milking cluster, there is also another problem with animals in a herd that have teat diameters outside what is normal for the herd. Milking is then not possible using the standard milking cluster for the herd.

For example, in the “Holstein” breed of cows, the effects of breeding mean that the teats of many cows have become so short and thin that the adherence of the milking cluster becomes increasingly poorer. Because of the wide variation in the size of the teats, it is often no longer possible to optimally adapt the teat rubber to the teats in one herd. For example, if the teats are too thin or too short, the milking cluster can often drop off, which is undesirable, or it does not stay properly in place. In the worst case, the animal in the herd can no longer be used for milk production and has to be given away or slaughtered.

There is therefore a need to protect the teats during the milking process and to compensate for deviations in teats that do not conform to what is normal for the herd.

This object is achieved by a method according to claim 1 and by a film according to claim 6 that can be used in the method.

According to the invention, a film that is self-adhesive and that adheres to the skin via an elastic adhesive coating is wound, particularly in an overlapping manner, around a teat, especially around injured or stressed skin regions of a teat, specifically during the milking process, which film can remain in place for protection on the teat over a period of several days, even between the repeated milking operations. In the text below, film is to be understood as a blank made from a composite material consisting of a planar support and of the adhesive layer. The film adheres to itself and to the skin via the adhesive layer.

Suitable films are known in principle to a person skilled in the art, for example from plaster materials or bandage materials. Taking into consideration the explanations given below, all the support materials and adhesive materials that are known in this connection can be used in the context of the invention.

In a first variant of the method according to the invention, the adhesive layer is chosen with a thickness and deformability such that, when the teat is stretched during the milking process, the adhesive layer compensates for shearing forces acting on the skin from the support coming into contact with the milking cluster.

Alternatively or in addition, in a second variant of the method according to the invention, the adhesive layer can be chosen such that, when a force acts on it in the longitudinal direction of the teat, it detaches from the skin without causing any appreciable damage to the corneocyte layer.

It has surprisingly been found that stressed or injured teats, and teats that do not conform to what is normal for the herd, are effectively protected during the milking process by the method according to the invention. The method cannot just be used on injured or irritated teats, and instead it can of course also be used on intact teats that are not stressed or irritated. In all cases, the film that has been applied in order to provide protection can easily remain in place on the teat for several days and over several milking operations.

In one variant, the film used in the method according to the invention is prepared with an adhesive layer having a thickness and deformability that ensures that, when the teat is stretched during the milking process, the adhesive layer compensates for shearing forces acting on the film from the milking cluster, such that these shearing forces do not place an additional load on the skin.

The adhesive layer is preferably made elastic in such a way that, after the shearing forces acting on it cease, it deforms back again substantially to its original shape, i.e. the shape it had before the action of the shearing forces.

In this variant, the adhesive layer is preferably also chosen such that it does not detach from the skin during the milking process. In this embodiment, the skin is treated particularly gently.

Alternatively, or in combination with the properties mentioned above, the adhesive layer provided in the film can be chosen such that, when the film or support stretches in the direction of stretching of the teat, the adhesive layer detaches from the skin incrementally and in the direction counter to the direction of stretching, and subsequently adheres again to the skin. It is essential to the invention that the adhesive layer detaches from the skin without appreciably damaging the corneocyte layer.

Adhesive layers having such properties are known in the field of wound plasters. They permit painless removal of plaster materials from the skin. For example, U.S. Pat. No. 4,224,313 discloses a corresponding self-adhesive, stretchable and flexible bandage which, by stretching it lengthwise parallel to the surface of adhesion, can be released easily and substantially painlessly from the skin surface. By stretching, the adhesive strength between adhesive layer and surface at the first contact point is exceeded by the tensile force. The adhesive layer generally detaches from the skin without removing corneocytes.

In both variants, the adhesion points lie closely on the skin of the unstretched teat and also generally span any folds in the skin, and it is ensured that the skin covered by the film is not additionally irritated during the milking process by the adhesive connection. In the first case, the adhesive follows along with the movement of the skin, i.e. the connections between skin and adhesive layer are maintained at the individual adhesion points.

In the second case, the adhesive detaches incrementally from the skin, such that the corneocyte layer is undamaged or only slightly damaged and automatically balances the stresses that occur across the detachment and readhesion. In this case, it is advantageous, but not absolutely essential, that the adhesive layer compensates for the acting tensile forces since, when the stretching starts, the adhesive bond detaches incrementally, such that during the milking process the film can detach in large parts but then immediately adheres again free of stress when the massage pressure of the milking cluster acts on bandage and teat.

In one embodiment of the invention, the adhesive layer is advantageously chosen such that it compensates for shearing forces up to a predetermined value and, above said value, detaches from the skin substantially without causing injury and, when said value drops, adheres again to the skin. With this embodiment, which combines both effects with each other, it is also possible to compensate for extreme conditions, e.g. when the teat is stretched more than usual, or when there is a non-optimal arrangement of the film, etc.

It is also suitable in principle to use foams, for example, made of three-dimensionally crosslinked adhesive compounds as described above, e.g. of polyurethane, which, shortly before or during the crosslinking that takes place, can be formed physically (e.g. by introduction of gas, such as nitrogen, carbon dioxide, noble gases or mixtures thereof), by gas formation caused by a chemical reaction (e.g. by formation of carbon dioxide from a reaction of isocyanate with water) or by evaporation of a low-boiling solvent during the crosslinking (e.g. pentane). Such foams are likewise adhesive, adhere subjectively more gently and, by virtue of their porous structure, can take up secretions more quickly compared to their unfoamed variants.

In another preferred embodiment of the method, the film is wound several times around the teat. This provides particularly effective protection against trauma from the outside.

Moreover, as is provided for in another preferred embodiment, the thickness of the winding can be used, if necessary, to ensure that the diameter of a teat not conforming to what is normal for the herd can be adapted to a milking cluster.

As has been mentioned, the invention relates not only to a method but also to a film that can be used in the method and that protects skin regions of a teat during the milking process.

A film according to the invention is a self-adhesive blank made from a composite material consisting of an adhesive layer with a planar support arranged on one side of the latter. In a first variant, the adhesive layer has a thickness and plastic and/or elastic deformability ensuring that, when the teat is stretched during the milking process, the adhesive layer compensates for shearing forces acting on the skin from the film.

Alternatively or in addition, the adhesive layer, in a second variant, is designed such that, when a force acts on it in the longitudinal direction of the teat, it detaches from the skin without causing any appreciable damage to the corneocyte layer.

In the first variant of the film according to the invention, the thickness and deformability of the adhesive layer are preferably chosen such that, when the teat is stretched during the milking process, the adhesive layer is not detached, or is detached only slightly, from the skin. This is possible since much of the shearing force transmitted to the film by the milking cluster is not transmitted to the skin but is instead balanced in the adhesive layer by deformation thereof, before said force can act on the skin.

The thickness of the adhesive layer used is preferably between 150 and 3000 μm, preferably between 200 and 2000 μm, particularly preferably between 250 and 1000 μm. The deformability of the adhesive layer should preferably be such that the support of a film that is affixed flat to steel can move back from the edge of the plaster toward the center of the plaster by at least 100% of its height, preferably by more than 300%, particularly preferably by more than 500%, without the adhesive layer coming loose from the steel plate. In other words, in the case of an adhesive layer with a thickness of 1 mm, the support in this embodiment can move back by at least 1 mm, preferably by >3 mm, particularly preferably by >5 mm.

Moreover, provision is preferably made that the adhesive layer has an elasticity which is particularly preferably such that, after release of the support in the above-described test method, the adhesive layer deforms back again to its original shape.

When the film is secured by means of an adhesive layer, the adhesion points of the adhesive layer usually lie closely on the skin (corresponding to the surface structure of the skin at the raised areas of the skin surface) of the unstretched teat and also generally span deeper-lying areas or folds on the skin. If the deformability or elasticity is too low, the adhesive layer cannot fully compensate for the acting tensile forces, and in the tension areas the adhesive strength of the adhesive layer to the skin is exceeded. The consequence is that, during the milking process, the film comes loose in large parts.

This tendency of the adhesive layer to come loose from the teat under tensile loading increases the thinner the adhesion layer. The thicker the adhesion layer, the more the tensile force can be absorbed in the adhesive layer by deformation thereof.

The thickness, elasticity and, if appropriate, plastic deformability of the adhesive layer are therefore advantageously adapted to one another such that, with the forces acting on it during the milking process, the adhesive layer can take part at least in the stretching of the teat, without significantly coming loose from the teat skin.

It is also particularly advantageous if the film as a whole, not just the adhesive layer, is designed such that, with the tensile forces normally occurring in milking clusters, it is stretchable by at least 50% of its extent in the direction of the teat. The film can preferably extend according to the lengthening of the teat.

Both constituent parts of the film are essential to the invention. In the text below, further details will be given in particular of the adhesive layer, since this comes into direct contact with the skin of the teat that is to be protected. The following explanations essentially apply to both variants of the invention.

An important property of self-adhesive layers is the flowability of their skeleton structure. Here, a rough distinction can be made between adhesive layers that begin to flow within physiological temperature ranges and in particular under pressure (so-called cold flow) and adhesive layers that do not exhibit this property.

Adhesive layers that exhibit cold flow generally adhere much more firmly to the skin some time after application, since they can adapt to the irregular surface structure and can flow around fine hairs, and, as a result, the adhesive surface that finally comes into contact with the skin is much greater per unit of surface area.

Consequently, adhesive layers that provide good adhesion, with an adhesive strength of 1.5-4 N/cm on steel, and that exhibit cold flow, have a tendency to what is called corneocyte stripping and generally tear off the uppermost layer of skin when they are detached from the skin.

Adhesive layers that do not exhibit cold flow adhere only under the pressure and, if appropriate, also during the application. In adhesive layers without cold flow, corneocyte stripping is not generally observed, even at the adhesive strength values mentioned above. Even after they have been removed from the skin, the adhesive layers can be affixed to the latter again, although the adhesive strength on the skin may then be slightly reduced.

Therefore, in the context of the invention, adhesive layers are preferred which, on account of their generally covalently crosslinked skeleton structure, do not exhibit cold flow per se, or do not exhibit cold flow adversely affecting the application according to the invention, but still have high adhesive strength. These include polyurethane adhesive layers, e.g. three-dimensionally crosslinked polyurethane adhesive layers, silicone adhesive layers, acrylate adhesive layers, synthetic rubber adhesive layers and hydrogels. This is a non-exhaustive list of some examples of suitable adhesive layers. In the context of the invention, other adhesive layers known to a person skilled in the art can of course also be used.

Adhesive layers preferred in the context of the invention and without cold flow have adhesive strengths on steel of >0.5 N/cm, preferably >0.7 N/cm, particularly preferably >1 N/cm. The adhesive strengths indicated relate to adhesive strength measurements on standardized steel plates, since adhesion to the skin can be measured directly only with considerable difficulty. This is a standard method known to a person skilled in the art.

It is also important for the method according to the invention, and for the film too, that the adhesive layers used are sufficiently dimensionally stable under the effect of pressure on a surface having the warmth of skin. The adhesive layer should not permanently deform on the teat under the effect of the massaging pressure of the milking cluster in combination with the physiological temperature of the skin. If the adhesive layer, and therefore the film, permanently deforms according to the pressure conditions, the efficiency of the milking process may deteriorate over time upon repeated attachment of the milking cluster, since the smooth surface of the milking cluster, upon repeated attachment, no longer bears on a smooth surface of the film, but instead on a surface that is deformed according to the pressure conditions of the first milking process.

Adhesive layers are therefore preferred which do not deform permanently under pressure but deform elastically, such that they almost completely recover their original shape after the milking cluster has been detached.

Moreover, the adhesive layer used according to the invention should be sufficiently permeable to water vapor, such that the skin lying underneath it does not macerate, especially after prolonged periods of application. Maceration is undesirable since it makes the skin much more susceptible to attack by germs. Although adhesive layers that are not permeable to water vapor or absorb moisture can be made permeable by perforation, they nevertheless exhibit cold flow, and the pores can then easily close again, especially after prolonged periods of application and under the effect of pressure. Air-perforated rubber and acrylate adhesive layers in particular exhibit such behavior.

Adhesive layers are suitable which per se are permeable to water vapor, which contain pores that cannot close during use, or into which moisture-absorbing fillers are incorporated.

Hydrogel adhesive layers would also be conceivable. However, a problem is that they have a moistening action and can therefore lead to maceration when used on the skin.

Therefore, preferred adhesive layers are in particular polyurethane adhesive layers, silicone adhesive layers or partially crosslinked hydrocolloid adhesive layers, which together with the support have a water vapor permeability of at least 300 g/m² in 24 hours, preferably 500 g/m² in 24 hours and/or can take up at least these amounts of moisture from the skin surface within this period of time and bind them in the adhesive layer and/or the support.

Moreover, despite the high adhesive strength, the adhesive layer in both variants should preferably be configured in such a way that dirt adhering to the edges of the bandage can be removed without much difficulty and the surface disinfected. This is particularly important, since the considerable thicknesses of the adhesive layers (150-3000 μm), especially when punched from films of planar material, mean that the individual film portions can have a relatively high adhesive edge on which dirt can adhere and remain. Adhering dirt can be easily removed if in fact the adhesive layer, as is preferred according to the invention, exhibits only slight cold flow or no cold flow, such that adhering dirt adheres only superficially and cannot be encapsulated by the adhesive layer and can be easily removed by moist mechanical cleaning, as is customary, for example, in the disinfection of teats.

If there is an injury on the skin, the wound is disturbed not only by the milking process but also each time the film is applied and removed, and any scab that has formed is generally torn off again with the removal of the bandage. This delays wound healing quite considerably and prevents rapid reintegration into the standardized procedure, which further increases the economic loss.

Therefore, provision is also preferably made that the adhesive layer according to the invention adheres well to the skin surrounding a wound but does not adhere in contact with the moist wound surface. Instead, it maintains a moist environment on the wound surface comparable to the environment under a natural scab. Therefore, the film does not adhere in the wound bed and thus promotes accelerated healing of the wound. Ideally, this is a purely physical effect that can be observed without the addition of active substances. However, it does not rule out the use of active substances with, for example, a disinfecting action (e.g. silver ions), a curative action (e.g. dexpanthenol) or an analgesic action (e.g. lidocaine), which are usually used for such injuries and which have been introduced into the film, in particular into the adhesive layer, or have been applied thereto.

The adhesive layer should also have the least possible sensitization potential.

The oxygen permeability of the film is also an advantageous parameter ensuring that the skin, even when covered for several days, is still able to breathe through the bandage. Otherwise, the skin of the teat could become irritated by this, and the animal would try to lick the film off. This contributes to the film being able to be left in place on the teat for days at a time, which in turn increases the protection of the teat.

As has already been stated above, the method according to the invention and the film are also designed to protect injured skin regions of a teat during the milking process. In order to be able to monitor the course of healing, provision is made, in another advantageous embodiment of the invention, that the film and the adhesive layer are transparent, such that the user is able to inspect the state of the teat through the film.

In another embodiment according to the invention, provision is made to indicate when the wound under the bandage has substantially healed. If, for example, particles are introduced into the adhesive layer that are able to bind liquid, these particles change their grain size and their refractive index when they take up liquid, and the film that is transparent per se becomes cloudy at the place where the film has taken up the liquid. If the entire film is permeable to water vapor, the moisture that has become bound in the meantime in the particles is released into the environment through the face of the film directed away from the skin. The moisture, as has already been described above, is transported through the film. As long as wound secretions and therefore moisture are conveyed out of the wound, the bandage remains cloudy at the place below which the wound is located. However, as soon as new epithelium has formed, no more body fluid is conveyed from the body. Moisture that is already bound in the bandage, however, is still released into the environment, the bandage slowly losing its cloudy appearance and beginning to become transparent again. This can be considered as a reliable sign that the wound covered by the bandage has healed and the bandage can be removed.

A bandage configured according to the invention changes optically when it comes into contact with wound secretions and takes these up, with the result that it differs distinctly from regions that come into contact only with the skin. This optical change reverses as soon as there is no more flow of wound secretions.

In conjunction with this, it is of great importance that a film according to the invention does not release absorbed wound secretion again under pressure, in other words the pressure exerted by the milking process is not sufficient to press wound secretions out of the film. This can be achieved by admixing superabsorber particles to the adhesive layer, such as are known, for example, from the manufacture of diapers. Suitable particles are commercially available, for example under the name FAVOR T 5233.

Finally, provision is also made that the film is colored or can be identified by its color. In this way, the livestock owner can, if necessary, quickly identify those animals in the stall that have been treated and are therefore under close supervision, even when they are still being kept with the rest of the herd.

The method according to the invention and the film according to the invention can be optimized by advantageous embodiments of the support.

Supports that are suitable in principle can all consist of all flexible planar materials that permit a planar blank and, for example, have the properties known from the technical field of plasters or bandages. Supports used here are, for example, wovens, knits, nonwovens and films, and combinations of these materials. Suitable films are, for example, polyethylene films, polyurethane films, copolyester films, polyamide films and co-extruded films. Suitable nonwovens are, for example, cellulose acetates, polyester nonwovens or polyamide nonwovens. The materials indicated above represent a non-exhaustive list of examples. A number of other materials known to a person skilled in the art are of course also suitable for production as support.

According to an advantageous embodiment, a support is used which, for its part, is likewise stretchable in the direction of the teat. The stretching should be chosen such that, with the forces normally occurring in milking clusters, the support with the adhesive layer is able to stretch in the direction of the longitudinal axis of the teat to at least >50%, preferably >100% of its extent in this direction. It is particularly preferable if the support and the adhesive layer can stretch substantially in synchrony with the lengthening of the teat.

The stretching of the support can take place both through elongation and also elastic extension with all intermediate percentage ratios between elongation and elasticity.

Provision is preferably made that the support is also stretchable transversely with respect to the longitudinal axis of the teat. Here too, the stretching can again be attributable to elasticity or elongation.

As a rule of thumb, it can be stated that a force of ca. 50 kPa is able to stretch the teat of a cow to a value of 140-150% of the original length, as is required for milking. At approximately this force, the stretching of the support should also take place to similar lengths. These values are only examples. The values can deviate considerably depending on the milking system and on the animal milked, the forces that occur in each case being well known to a person skilled in the art.

The surface of the support directed away from the adhesive layer should be configured in such a way that dirt customarily found in a stall cannot adhere to or penetrate into the surface of the support, or can do so only to a limited extent. Slightly adhering dirt must be able to be removed without any problem. The surface must also be able to be disinfected using conventional agents such that, after coarse dirt has been removed, any germs still present on the surface can be killed. Preferred supports are therefore macroscopically smooth films, for example polyurethane, polyethylene or polyester films or composites of several different materials that are visibly smooth, germ-proof and flexible. For this reason, supports that are less suitable but still possible are more strongly structured surfaces, for example knits, wovens or nonwovens, even when made hydrophobic.

The support is ideally germ-proof itself or in conjunction with the adhesive layer and also remains so upon stretching or elongation.

Provision is advantageously made that the support is not plastically deformed by the continuous pressure and tension load, which changes in the millisecond range and runs through a complete cycle more than once per second, and is at all times able to assume its original shape again. If, in an extreme case, only the adhesive layer is elastic, while the support can only be elongated, the restoring force of the adhesive layer causes folds to form in the covering support, and although these folds do not impair the function of the film they are not ideal, since dirt can additionally become trapped in them.

An important aspect of the invention is that the film is applied in an overlapping manner and adhering to itself. In this context, it is important that the adhesive layer adheres not only to the skin but also to the outwardly facing surface of the support. The adhesive connection should be so firm as to ensure that the film does not separate and unwind spontaneously or under mechanical effects, for example the milking process or the licking action of the animals.

In an advantageous embodiment, provision is made that the film overlaps itself by at least 5% relative to the teat circumference. It is important, particularly in this embodiment, that the adhesive layer adheres to the support at least just as well as it does to the skin.

In the context of the invention, however, the film can also be wound several times around the teat. On the one hand, this permits particularly good protection of stressed regions of skin. On the other hand, teats with too small a diameter can in this way be easily adapted to existing milking clusters, and this makes it possible to milk teats that are too small and deviate from the herd standard.

A particularly preferred film has a support coated with a self-adhesive polymer matrix that exhibits no cold flow or only slight cold flow. As an example of an embodiment of an adhesive layer relevant to this use, reference is made to qualities of the kind sufficiently described in the patent EP 0 897 406. The degree of crosslinking preferred for the use according to the invention, and characterized as the isocyanate number as described in EP 0 897 406, preferably lies in the range of 41-47, without wishing to exclude the numerical ranges mentioned in the aforementioned patent. The polymer matrix described in said patent has added to it preferably 5-20% of a filler relative to the amount of polyol used, which filler is able to absorb and bind aqueous liquids, without wishing to exclude the filler amounts and qualities mentioned in the aforementioned patent and in patent EP 0 665 856. The adhesive layer thus characterized is covered with a highly flexible polyurethane film permeable to water vapor and to oxygen, without wishing to exclude the alternative films mentioned in the aforementioned patents. In order to protect the face of the adhesive layer prior to use, the product is covered with commercially available release papers or release films that are familiar to a person skilled in the art for self-adhesive products and that have to be removed before use.

The product for the use according to the invention can be punched or cut out as an individual plaster from planar material, or it can be cut off from a roll. By cutting off a section of plaster tailored to the size of teat, the latter option permits simple adaptation to different teat circumferences. Plasters can also be cast individually, however. By way of example, reference is made to methods of the kind described in patent application EP 1 695 721.

Provision can preferably be made that the blank is shaped in a manner adapted to the skin region of the teat that is to be covered. Generally, teats have a conical shape that becomes increasingly narrower toward the bottom of the teat.

In one embodiment of the invention, provision is therefore made that the blank is designed in the form of an arc-shaped strip with a radius adapted to the conicity of the teat. According to this embodiment, different blanks can be provided for different height regions of the teat. In the upper and somewhat cylindrical region of the teat, blanks that are preferably slightly curved can be used for optimal fixing, whereas in the lower and more strongly tapering region, more strongly curved blanks can be better applied, i.e. without creating folds. A set of blanks with arc-shaped strips of different curvature is conceivable, for example, from which the user can choose the one most suitable for the teat region that is to be covered.

Further embodiments concern the tip region of the teat. In this connection, provision is preferably made that the blank forming the film surrounds a through-hole, of which the diameter corresponds at least to the diameter of the outlet opening of a milk channel extending in the teat. The film can thus be affixed optimally to the tip of a teat and to the adjoining area of the teat, care simply having to be taken to ensure that the hole provided in the blank is oriented flush with the outlet arrangement of the milk channel. With such a film, the tip region of a teat can be affixed in a particularly simple way while maintaining milkability.

This embodiment can be optimized by configuring blanks that are particularly well adapted to the surface profile of the tip of the teat and are thus able to be affixed without protruding edges or folds.

It is conceivable, for example, to use a blank in which, in the area of the hole, incisions are made extending in from the lateral edge to the hole. The incisions mean that the blank can be affixed from the tip of the teat upward, and around the end area of the teat adjoining the tip, without causing folds or bulges. The blank can be optimized by the number of incisions or by the shape of said incisions. It is conceivable, for example, for the incisions to widen in a V-shape toward the outside.

In another embodiment, the blank has a central portion which surrounds the hole and from which at least one strip-shaped portion extends radially with respect to the hole. It is particularly advantageous to provide several radially extending strip-shaped portions. A teat plaster configured in this way is affixed with its central area onto the tip of the teat in such a way that the hole is flush with the outlet opening of the milk channel. The radially extending strips are then placed on the teat, oriented upward in the direction of their extent, and are affixed to the teat. In this embodiment, the entire tip of the teat is covered completely by the film (except for the area of the outlet channel), and the adjoining end area of the teat is covered partially by the film, since free spaces remain between the strip-shaped portions. This can suffice depending on the nature or location of the injury and skin irritation.

However, if a complete covering is wanted, a further embodiment provides that additional laterally protruding portions are provided on at least one of the strips of the blank that extend radially from the hole. These laterally protruding portions can, for example, have the form of a strip of desired width.

The film is applied in the manner described above. Once again, for example, the central portion surrounding the hole is first affixed to the tip of the teat. The radially extending strip or strips are then placed on the teat, oriented upward in their direction of extent, and are affixed to the teat. The portions laterally protruding from this strip are then placed around the teat and are also affixed thereto. In this way, an end area of the teat directly adjoining the tip of the teat can be covered completely by the film, without kinks or folds occurring.

In another embodiment, provision is made that the film has at least one adhesive strip suitable for temporarily covering the hole between milking operations. Ideally this involves one or more separate adhesive strips, which are each reaffixed to the film after the milking operation in order to close the hole.

It is surprising to a person skilled in the art that, under the high loads to which the material is exposed during the teat-cleaning and milking process and under the hygienic conditions of a dairy farm, films described in the context of the invention sit securely in place, do not slip and remain on the teat for several days, without showing any tendency to come loose. This applies to manual milking, to the use of semi-automatic milking machines and also to the use of fully automatic milking robots. Even in the extreme example of milking robots, the films easily withstand repeated disinfection, cleaning with rotary brushes, milking, and also subsequent cleaning. In summary, this is basically achieved by the use of a flexible support coated with a flexible adhesive layer having no cold flow, the film being affixed in an overlapping manner such that it adheres to itself to a certain extent.

Surprisingly, despite the excellent adhesion to the teat, such a film can also be easily removed by unrolling it. It is also surprising that the animals wearing the film show only a slight tendency to lick the film off.

The method and the film according to the invention can be used on all livestock animals that are used for milk production, e.g. cows, sheep, goats, yaks, camels, horses, etc.

The invention is directed not only to the claimed method and to the films that can be used in the method. It also relates to the use of such films for protecting skin regions in the end area of the teat during the milking process.

The invention is explained in more detail below on the basis of an example of a suitable film and with reference to a number of figures.

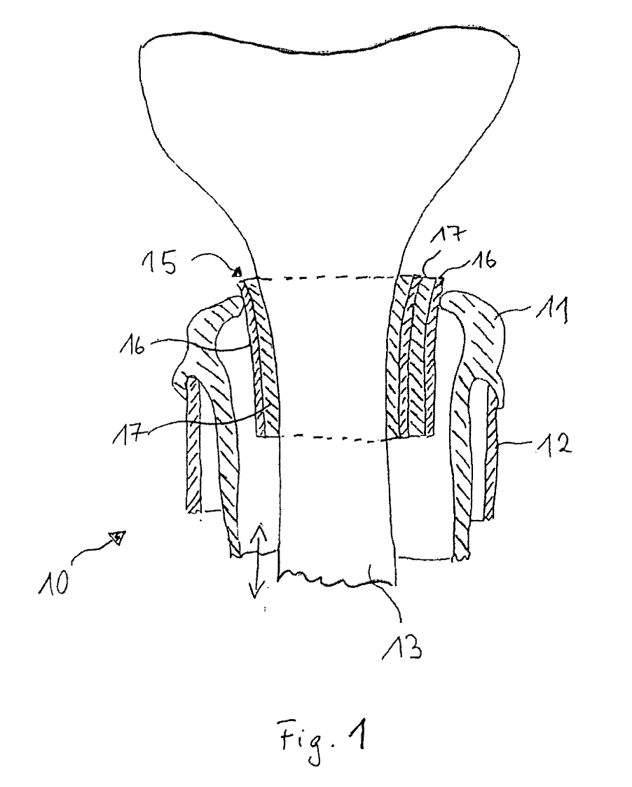

FIG. 1 shows a schematic representation of a teat which is arranged in a milking cup and which has a film affixed to it.

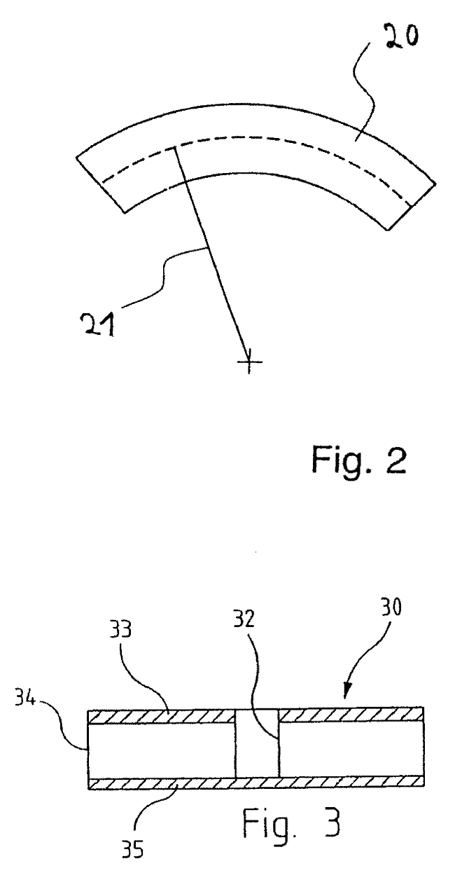

FIG. 2 shows a blank, in the form of an arc-shaped strip, for a film conceived for the upper region of the teat.

FIG. 3 shows a cross section through the composite material used to produce the film according to the invention.

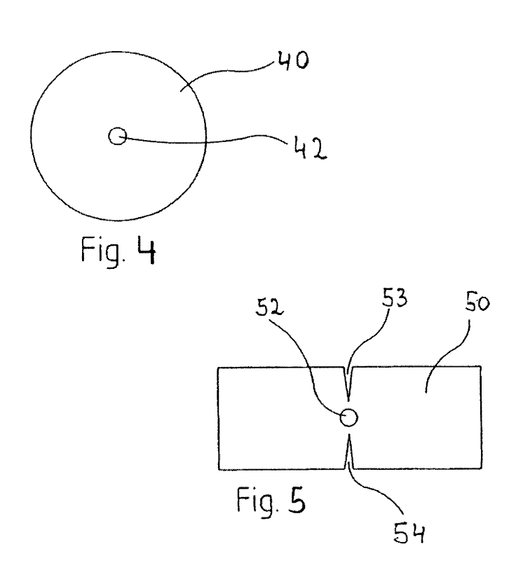

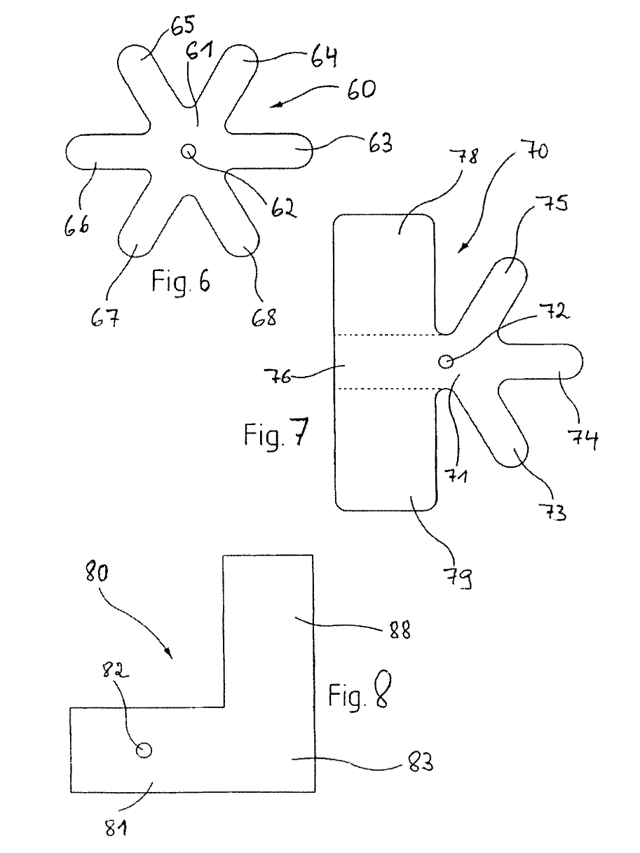

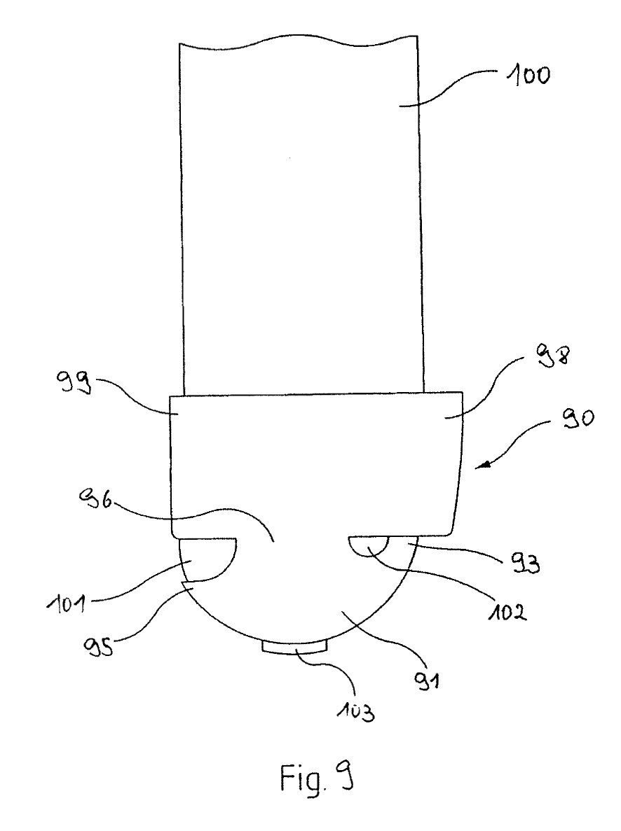

FIGS. 4 through 8 show different embodiments of blanks for films conceived for the tip of the teat.

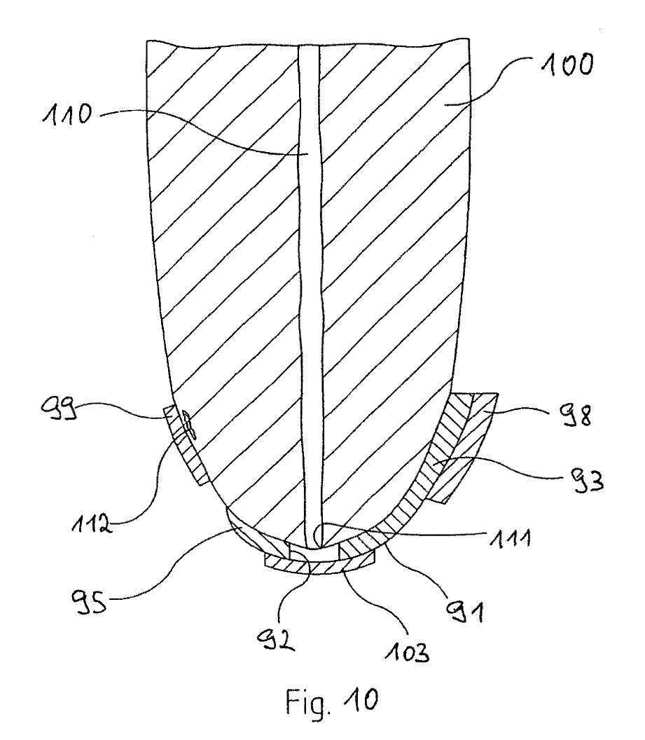

FIG. 9 shows the end area of a teat with affixed film.

FIG. 10 shows the view from FIG. 9 in a longitudinal section.

### EXAMPLE

A suitable film is composed of an approximately 40 μm thick, highly flexible, water vapor-permeable, oxygen-permeable and germ-proof polyurethane film (Applica, Smith & Nephew) as support, which is coated with a self-adhesive and highly flexible polyurethane adhesive layer with a thickness of, for example, 300 μm or 800 μm.

The adhesive layer was produced by homogenizing 100 parts by weight of polyol (Levagel VP KA 8732; OH number 35) with 12 parts by weight of superabsorber (Favor T 5233), 0.1 part by weight of catalyst (Coscat 83) and 0.8 part by weight of vitamin E (Irganox E 201) in a 1-liter apparatus for 2 hours at room temperature. Thereafter, 6.6 parts by weight of crosslinker (Desmodur E 305, NCO content 12.2%) were added to 100 parts by weight of this mixture, and these were mixed intensively for 1 minute with a glass rod.

This mixture is then poured onto a commercially available, siliconized release paper, covered with the polyurethane film serving as support, and spread out flat with the aid of a doctor blade, such that the composite has a thickness of approximately 300 μm or 800 μm, and then set in a drying cabinet for 18 minutes at 80° C. A transparent film is obtained.

Strips with a width of 4 cm, for example, are cut out from the resulting planar structure. The width can of course vary and can be chosen according to the length of the teats. A strip with a width of 4 cm is, for example, suitable for a teat length of 4.5 to 6 cm.

If the teat is considerably longer than 4.5 to 6 cm, a strip of greater width can be cut out, or a strip with a width of 4 cm is first wound around the lower part of the teat, and then another is wound around the upper part, or vice versa, in which case the two windings must overlap each other.

For a standard teat diameter of 2.6 cm, the length of the strip should be chosen at approximately 12 cm. The release paper is pulled off and the film is placed without stress around the teat and pressed on, such that the film makes one complete loop around the teat and adheres to itself by approximately a further 50%.

The film applied in this way can be left in place on the teat for several days and cleaned before milking, the milking cluster applied, the animal milked, and the milking cluster removed again, without the bandage coming loose.

If the teat is too thin to be milked with the standard milking cluster for the herd, a correspondingly longer piece can be wound several times around the teat. The teat diameter can thus be increased, for example, from 2.6 to 2.8 cm using three layers of the film. In the present example, the milking cluster then fits securely again.

Since the film is transparent, the user is able at any time to inspect the teat skin through the bandage.

If the teat has an injury, the film is applied in exactly the manner described above. In this case, the film assumes the function of a scab and protects the wound from contamination and germs. Excess wound fluid is absorbed slowly by the film. At the place where the film absorbs the secretion, the film loses its transparency and becomes cloudy. Milking can still be carried out even now. Wound secretions are not pressed out of the film, and the udder quarter does not have to be drained. When the wound under the film has healed, the film loses its cloudy appearance and becomes transparent again. If it has been applied to treat the wound, the film can now be removed again easily and with practically no force being applied. This is done by simply unrolling it from the teat, from the top downward.

FIG. 1 is a schematic representation of an udder with a teat 13. The teat is received in a customary milking cup 10, which comprises an outer steel sleeve 12 and a teat rubber 11 fitted on the latter.

By alternate application of vacuum in the teat rubber or in the area between rubber 11 and sleeve 12 surrounding the teat rubber, the milking operation is performed and the teat is also massaged. These operations are known to a person skilled in the art. They are not discussed in any more detail here.

As is indicated schematically, a film 15 is wound around the teat 13, with one layer on the left-hand side and two layers on the right-hand side. The film 15 is a composite of a support 16 and of an adhesive layer 17, with which it is secured, adhering to itself, on the teat 13.

During the milking operation, the teat 13 is stretched downward in the direction of the arrow.

According to the invention, provision is made that the adhesive layer 17 either tolerates this stretching, i.e. takes part in it, or shears off tangentially at the moment when a force is applied to the adhesive layer 17 via the downwardly stretched teat, after which it adheres sufficiently firmly again when next pressed on by the teat rubber.

In the first case, provision is made that the support 16 advantageously performs the stretching movement too, since otherwise shearing forces would act on the teat via the adhesive layer. This is not necessary in the second case.

FIG. 2 shows an embodiment of a blank 20 for a film, which is suitable in particular for the shaft area of the teat. The blank 20 is in the form of an arc-shaped strip with a radius 21 that is chosen such that the strip can be affixed optimally to the cone-shaped teat. It will be appreciated that blanks with different radii can be made available in a set, from which the user chooses the most suitable one depending on the shape of the teat.

FIG. 3 shows, in cross section, the basic structure of a film that can be used in the context of the invention. Seen from the top downward, the film 30 has a support 33, an adhesive layer 34, and a cover 35 to be removed before the film is applied. In the case shown here, the film also has a hole 32 which, as has been mentioned above and as is explained in the following embodiments, is necessary for use in the area of the tip of the teat. It will be appreciated that the hole 32 can be omitted in films that are not intended to be applied in this area of the teat.

FIGS. 4 through 10 show embodiments that relate to specific films conceived for the tip area of the teat.

FIG. 4 shows a plan view of a circular blank 40, which surrounds a hole 42. Although this is the simplest embodiment, it is not able to be optimally affixed in all circumstances.

FIG. 5 shows a plan view of another blank 50 for the teat plaster according to the invention. This blank 50 also surrounds a hole 52. Moreover, the blank 50 is provided with incisions 53 and 54 extending from the edge of the blank 50 toward the hole 52. These incisions are intended to make it easier to affix the blank 50 to the tip of the teat. It will be appreciated that such incisions can of course also be formed in the blank shown in FIG. 4, or in other forms of blanks, and have the same effect there. It is of course also possible to provide still more incisions, or to configure the incisions differently, e.g. widening in a V-shape or U-shape to the outside.

FIG. 6 shows another embodiment of a blank 60 for a teat plaster according to the invention. The blank 60 has a central portion 61, which surrounds a hole 62. Strips 63 to are also provided extending from the central portion 61 radially with respect to the hole 62. When the plaster is applied, these strips 63 to 68 are guided up the sides of the teat and then affixed to the skin regions lying underneath. Such a blank ensures that the affixed plaster does not crease or form edges. However, uncovered areas remain in the end area of the teat.

In this connection, FIG. 7 shows another embodiment of a blank 70 for a teat plaster according to the invention. This blank also has a central portion 71, which surrounds a hole 72. As in the embodiment shown in FIG. 6, strip-shaped portions 73, 74, 75 and 76 extending radially from the hole are also provided here. Further portions 78 and 79 are provided on the strip-shaped portion 76 and extend to both sides of this portion. These portions 78 and 79 can be placed laterally around the teat and be affixed thereto and then completely cover the teat in a defined height range.

Another embodiment of a blank 80 is shown in FIG. 8. In this embodiment, a central portion 81 and strip-shaped portions 82 and 83 extending from the latter are shaped overall in the form of a strip. Here too, a lateral portion is provided which, as in the previously discussed embodiment, permits winding around the teat in a defined height range. As in all of the previously discussed embodiments, a hole 82 is provided in the central portion 81.

FIG. 9 shows an end area of a teat 100 to which is affixed a teat plaster with a blank 90, which corresponds approximately to the blank shown in FIG. 8. The blank 90 has a central portion 91, which is affixed over the tip of the end area of the teat 100. Strip-shaped portions 93, 95 and 96 can be seen extending from the central area 91 in this view. Lateral portions 98 and 99 are provided on the strip-shaped portion 96 and can be wound around the teat 100. It will be seen that the teat 100 is covered almost completely, and free of folds, by the affixed blank 90, except for areas 101 and 102. These areas too can be covered with suitable optimization of the blank.

FIG. 9, finally, shows a strip 103 with which the hole (not shown in this view) in the central portion 91 of the blank 90 can be covered.

FIG. 10 shows the view from FIG. 9 in longitudinal section. In this view, a milk channel 110 can be seen which runs through the end area of the teat 100 and which opens into an outlet opening 111. This view also shows that, in the central portion 91 of the blank 90, a hole 92 is formed that is arranged flush with the outlet opening 111 of the milk channel 110.

Of the strip-shaped portions extending from the central portion 91, only the portions 93 and 95 can be seen. The lateral portions 98 and 99 are also shown. In addition, the figure schematically depicts a wound 112 located in the end area of the teat 100 and covered by the lateral portion 99. It will also be seen here that the strip 103 covers the hole 92.

1. A method for protecting skin regions of a teat during the milking process, the method comprising winding a film in an overlapping manner around the teat, wherein the film is a blank made from a composite material consisting of a planar support with an adhesive layer by means of which the film adheres to itself and to the skin, the adhesive layer is chosen with a thickness and an elastic and/or plastic deformability such that, when the teat is stretched during the milking process, the adhesive layer compensates for shearing forces acting on the skin from the film and/or the adhesive layer is chosen such that, when a force acts on it in the longitudinal direction of the teat, it detaches from the skin without causing any appreciable damage to the corneocyte layer.

2. The method as claimed in claim 1, wherein the adhesive layer is chosen such that it compensates for shearing forces up to a predetermined value and detaches from the skin above said value.

3. The method as claimed in claim 1, wherein the adhesive layer is made elastic in such a way that, after the shearing forces acting on it cease, it returns again substantially to its shape.

4. The method as claimed in claim 1, wherein the film is wound several times around the teat.

5. The method as claimed in claim 4, wherein winding the film around the teat adapts the diameter of the teat to a milking cluster.

6. A film for the method as claimed in claim 1, wherein it is designed to adhere to itself and is a blank made from a composite material consisting of an adhesive layer with a planar support arranged on one side of the latter, the adhesive layer having a thickness and an elastic and/or plastic deformability ensuring that, when the teat is stretched during the milking process, the adhesive layer compensates for shearing forces acting on the skin from the film and/or the adhesive layer is designed such that, when a force acts on it in the longitudinal direction of the teat, it detaches from the skin without causing any appreciable damage to the corneocyte layer.

7. The film as claimed in claim 6, wherein the adhesive layer is chosen such that it does not detach from the skin during the milking process.

8. The film as claimed in claim 6, wherein, with the tensile forces usually occurring in milking clusters, it is stretchable by at least 50% of its extent in the direction of the teat.

9. The film as claimed in claim 8, wherein it stretches according to the lengthening of the teat.

10. The film as claimed in claim 6, wherein the adhesive layer does not show any cold flow disturbing the use thereof.

11. The film as claimed in claim 6, wherein the adhesive layer has an adhesive strength on steel of >0.5 N/cm.

12. The film as claimed in claim 6, wherein the thickness of the adhesive layer is between 150 and 3000 μm.

13. The film as claimed in claim 6, wherein the deformability of the adhesive layer is such that, when affixed flat to a steel plate, the support can move parallel to the steel plate over at least 100% of the height of the adhesive layer without the adhesive layer coming loose from the steel plate.

14. The film as claimed in claim 13, wherein the elasticity of the adhesive layer is such that, after release of the support in a measurement set-up as per claim 13, the adhesive layer deforms back again to its currently amended shape.

15. The film as claimed in claim 6, wherein the adhesive layer and the support have a water vapor permeability of at least 300 g/m² in 24 hours, or the adhesive layer and/or the support is/are able to bind corresponding amounts of moisture.

16. The film as claimed in claim 6, wherein the support and the adhesive layer are transparent.

17-19. (canceled)

20. The film as claimed in claim 6, wherein the blank is shaped to fit the skin region of the teat that is to be covered.

21. The film as claimed in claim 20, wherein the blank is designed in the form of an arc-shaped strip with a radius adapted to the conicity of the teat.

22. The film as claimed in claim 20, wherein the skin region to be covered is the tip of the teat, and the blank surrounds a hole passing through the composite material, the diameter of which hole corresponds at least to the diameter of the outlet opening of a milk channel.

23-25. (canceled)

26. The film as claimed in claim 20, wherein a cover is provided, with which the hole can be covered from outside between the milking operations.

27. (canceled)
